(19) United States
(12) Patent Application Publication
(10) Pub. No.: US 2006/0125910 A1
(43) Pub. Date: Jun. 15, 2006

(54) Packaging structure of LED-multiplexer/driver hybridzation for LED printer head

(76) Inventors: Jin Shown Shie, Hsinchu (TW); Thunter Hwang, Yongkang City (TW); Chin-Wen Huang, Hsinchu City (TW); Chien Chung Lin, Zhudong Town (TW)

Correspondence Address: PERKINS COIE LLP, P.O. BOX 2168, MENLO PARK, CA, 94026, US

(21) Appl. No.: 11/009,431

(22) Filed: Dec. 9, 2004

(51) Int. Cl. B41J 2/435; G01D 15/14

(52) U.S. Cl. 347/224

(57) ABSTRACT

The present invention discloses a packaging structure of LED-multiplexer/driver hybridization for LED printer head. In order to connect the LED-multiplexer module to the LED chip without wire bonding, a multiplexer chip, made of silicon material, has multiplexer circuit on one side and a through engraved U-shape trench on the other side, a linear array LED chip, made of non-silicon material, is stack-hybridized into the through engraved U-shape trench, to form a hybridized wafer with all the upper surfaces of LEDs and the multiplexer circuit in the same plane to form a co-planar surface. A plurality of joint-metal, made by photo-lithography and etching, screen printing of any solder paste, ink-jet printing of any appropriate solder paste or by lift-off method, is formed on said co-planar surface of said multiplexer circuit and linear array LED to connect the bonding pad of the multiplexer device and the positive electrode of the LED of each pixel.

### BACKGROUND OF THE INVENTION

1. Field of the invention

The present invention relates to a packaging structure of LED and multiplexer. In particular, the present invention relates to a packaging structure of LED-multiplexer/drive hybridization for LED printer head.

2. Description of the Related Art

There are many kinds of printers in the present-day electronic printing market. Among them, only laser printer and LED printer allow high speed and high quality color printing with ordinary plain papers. In comparable to ink-jet printer using its high-price printer head, the cost of each printing thus is greatly reduced.

The operation principle of both laser printer and LED printer is very similar to that of a copy machine. In which a rotating photoconductive drum is subjected to exposure of a light image and resulting n corresponding electrostatic charge image formed on the drum surface. The charges attract minute dye particles fed in onto the drum surface by the electrostatic force. These particles are transfer-printed onto a contacting paper to form a desire image. The differences are on the mechanisms of light exposure on the photoconductive drum. A laser printer transfers a light image onto the surface of the electrostatic drum by deflecting a pre-programmed laser beam through a high-speed (20000-60000 rpm) rotating polygon mirror. While a LED printer transfers the light image to the drum by projecting the light from each LED pixel on a linear LED array through a rod lens array in between. The light intensity of each LED pixel is pre-programmed by a controlling unit. The electronic signal from the unit is fed into a multiplexer unit in proximity the LED array to perform the corresponding scan-and-drive function on each LED for light emission.

Therefore a LED array and a corresponding multiplexer array are the indispensable elements to a LED printer. A LED printer has its most advantage of compact size compared to a laser printer. Its structure allows itself to be integrated with a CIS (contact image sensor) scanner to form a compact multi-function printer performing as a copier, a scanner, and a fax machine, in addition to the printer function. Another advantage of a LED printer is that the LED printer head is totally composed of non-moving parts by utilizing electronic scanning mechanism. Whereas in a laser printer the scan method is purely mechanical, this demands a polygon mirror in high-speed rotation, from 20 to 60 thousands rpm. Such high-rotation spin require precision adjustment for the wheel balance manually, thus the assembly is hard to be automatic.

However, packaging a series of the LED segments and associated multiplexer segments, and wiring in pairs of the two kind devices is not as simple as it is looked apparently, not even mention the numerous wirings to be made. The difficulty comes from line up in sufficient parallel of the LED segments with the multiplexer counter parts in die bonding process, even with modern high cost die-bonding machine. The non-parallel geometry of the LED and multiplexer tracks leads to a low yield rate of the subsequent automatic wire bonding between the pairing pixels of the two devices due to random variation of each wiring distance. Among thousands of wiring, failure of one or two wiring is fatal to the complete assembled module due to the difficulty of rework. This critical wire-bonding problem has limited LED printer to be emerged as a replacement of laser printer, despite of its advantages and the price-decreasing trend of LED devices nowadays.

A LED (light emitting diode) printer is an electronic printing device performing functions like that of a laser printer. FIG. 1 shows a single dot of the electrical structure. A LED 102 is controlled by the multiplexing device 104. As shown in FIG. 2, FIG. 2 illustrates multiple pixels of LED arranged in linear array geometry. As shown in FIG. 2, LEDs 202 are linked electrically to the nearby multiplexing devices 204 of same pixel number by mechanical wire bonding and then to the external controlling devices. These LED pixels therefore are capable of emitting light pulses sequentially by the scanning multiplexer and the controller. The emitted light pulses are collected by a rod lens array (not shown) in front of the LEDs and conjugate-projected onto a photoconductive drum (not shown) on the other side of the rod lens array, thus developing an image of electrostatic charges on the drum surface where light does not exposed. The electrostatic charges attract dye particles, which then are transfer-and-print onto a paper rolled over by the drum carrying the charges. Currently, a commercial color printer needs four sets of such mechanisms so that both black-and white and color images can be printed out.

Refer to FIG. 3. FIG. 3 illustrates the wire bonding of the LED pixels with the multiplexer chip. In such kind of printer, each printer head requires numerous bonding wires 310 to link each LED pixel 202 on the LED array chip 302 to the corresponding pixel of the multiplexing chips 304. For example, an A4 size printer of 600 dpi resolution needs 4800 linking wires to achieve this purpose. The tremendous wiring number makes the price for mass production of the LED printer considerably high. Not only because of it needs many high precision automatic wire bonders for sufficient productivity, but also it is quite difficult to line up in sufficiently parallel of the two kinds of chips, namely the LED chips 302 and the multiplexing chips 304 on a common substrate. Without enough parallelism, it is very hard for a wire bonder to work with high yield result. Therefore special precision die bonders are also require, making the investment even higher for producing LED printer.

Furthermore, the present technology needs more area for wiring on a chip than that for light emitting, especially in high-resolution printer. The size of a pixel is determined by the resolution. Take an example, a 600 dpi printer has an area around 43.5 microns by 43.5 microns (25430 micron/600), while a regular bonding pad area takes 100×100 micron square, which is larger than the former. Since it is impossible to arrange the bonding pads 308 in one line parallel to the LED chips 302 in such a situation, more lines are necessary in practical design, which leads to even more demanding of chip area of the linear array LED. In a commercial product the bonding pad area occupies over 70% of the total LED chip area. It turns out the cost of the devices in a printer intolerable high which results in no competition with a laser printer of the same grade, in despite of its superiority of compact size and capable of using automatic packaging tools.

In summary, developing a LED printer into commercial product with cost and grade comparable to that of a laser printer is impeded by the technique difficult of packaging the LED-multiplexer module, together with the high cost of LED chips. To make LED printers more economic and competitive with laser printers, the above obstacles must be overcome.

Therefore, there is a need to develop a technology to connect the LED-multiplexer module without wire bonding. So that the area of the LED chip may reduce and the cost of packaging may also reduce.

### OBJECTS OF THE INVENTION

It is therefore an object of the invention to provide a packaging structure of LED-multiplexer/drive hybridization for LED printer head,

It is another object of the invention to provide a packaging structure of LED-multiplexer/drive hybridization to connect the LED-multiplexer module to the LED chip without wire bonding

It is yet another object of the invention to provide a packaging structure of LED-multiplexer/drive hybridization by joint-metal, made by photo-lithography, screen print or lift-off, to connect the LED-multiplexer module to the LED chip, so that the area of the LED chip may reduce and the cost of packaging may also reduce.

### DISCLOSURE OF THE INVENTION

An aspect of the present invention teaches a packaging structure of LED-multiplexer/drive hybridization for LED printer head, comprising: A linear array LED chip, made of non-silicon material; A multiplexer chip, made of silicon material, has multiplexer circuit on one side and a through engraved U-shape trench on the other side, the linear array LED chip is stack-hybridized into the through engraved U-shape trench, to form a hybridized wafer with all the upper surfaces of LEDs and the multiplexer circuit in the same plane to form a co-planar surface; A plurality of joint-metal, made by photo-lithography, screen print of solder paste, ink-jet printing of solder paste or lift-off method, is formed on the co-planar surface of the multiplexer circuit and linear array LED to connect the bonding pad of the multiplexer device and the positive electrode of the LED of each pixel.

### BRIEF DESCRIPTION OF THE DRAWINGS

The foregoing and other advantages of the invention will be more fully understood with reference to the description of the best embodiment and the drawing wherein:

FIG. 1 shows a single dot of the electrical structure of the prior art.

FIG. 2 illustrates multiple pixels of LED arranged in linear array geometry of the prior art.

FIG. 3 illustrates the wire bonding of the LED pixels with the multiplexer chip of the prior art.

FIG. 4 is a schematic representation of the LED-multiplexer/driver according to one embodiment of the present invention.

FIG. 5 is a cross sectional view through the line A-A′ of FIG. 4 according to one embodiment of the present invention.

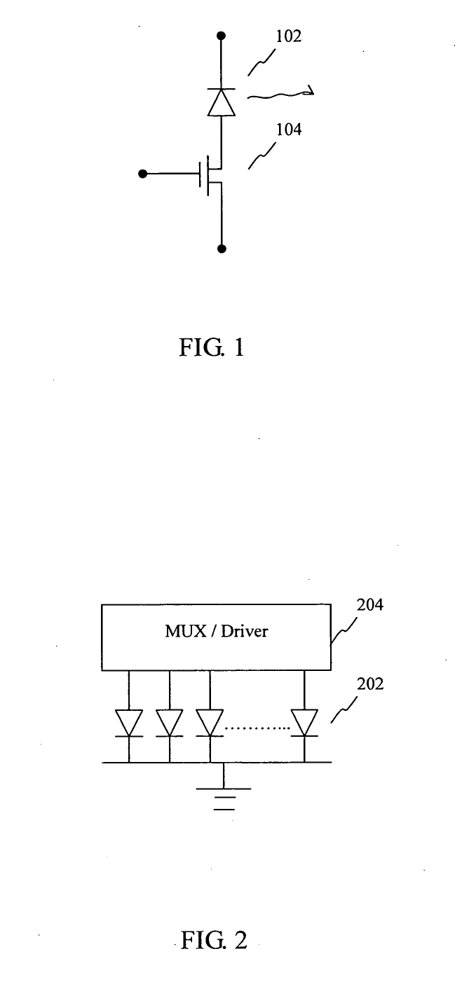

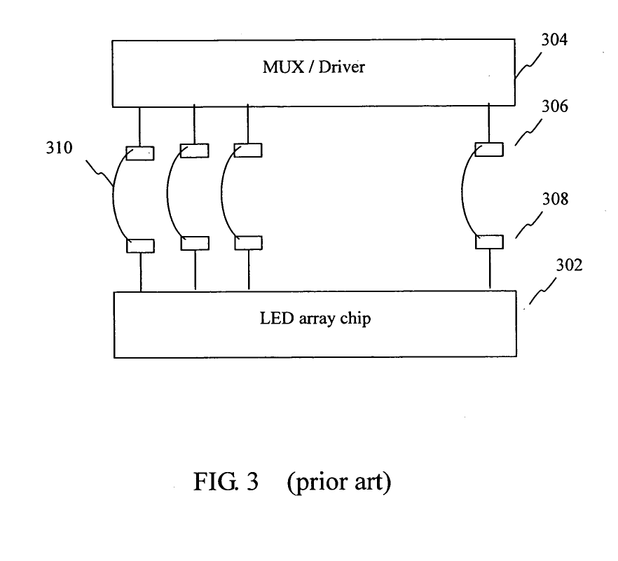

### DESCRIPTION OF THE PREFERRED EMBODIMENTS

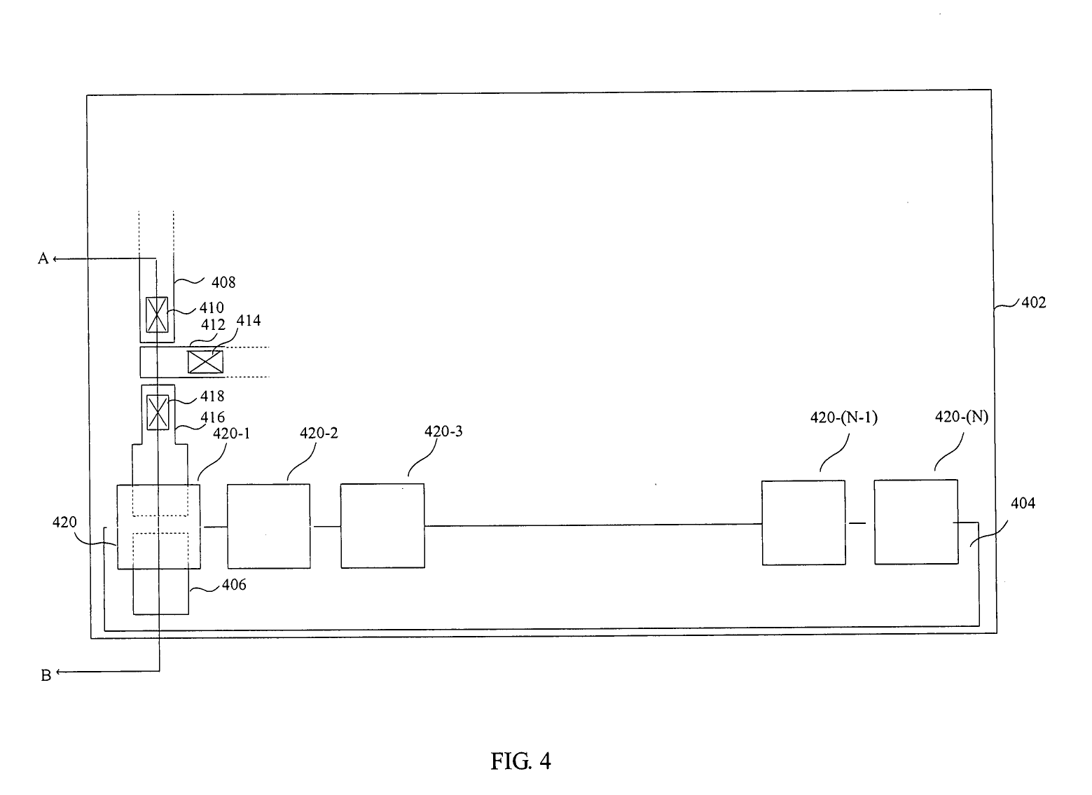

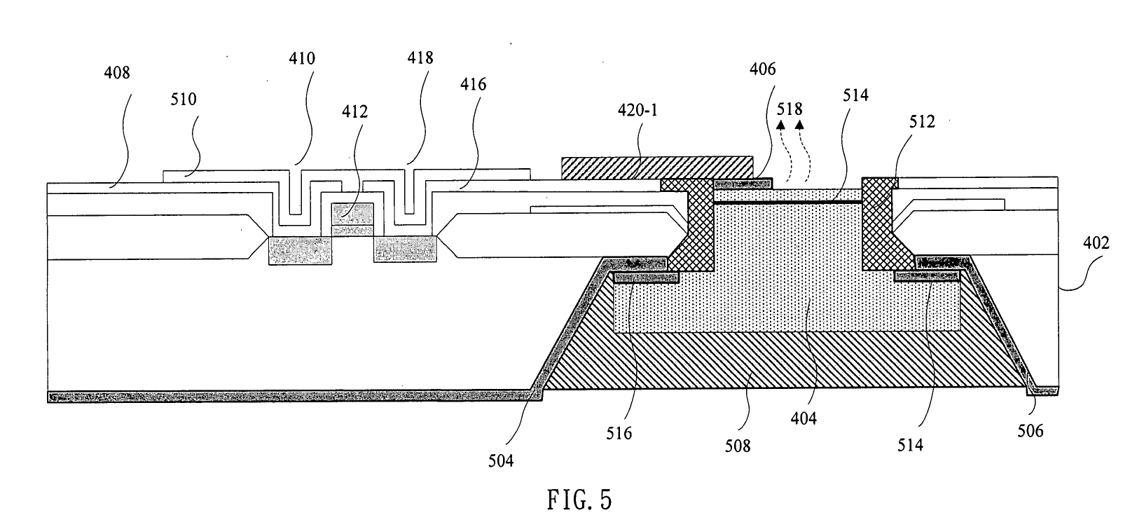

Referring to FIG. 4, FIG. 4 is a schematic representation of the LED-multiplexer/driver according to one embodiment of the present invention. A liner array LED chip 404, made of non-silicon light emitting material(III-V compound or II-VI compound), such as GaAs, GaAlAs, GaP, GaN, etc., is stack-hybridized into a through engraved u-shape trench (refer to FIG. 5), the upper surface of the LED array is in the same plane of the multiplexer circuit such that forms a co-planar surface, each LED has a positive electrode 406 on the surface, in FIG. 4 only one positive electrode 406 is shown, but it is understood that each LED has its positive electrode, FIG. 4 also shows only one multiplexer device. The source electrode 408 with contact hole 410 connects the source to the multiplexer circuit, gate electrode 412 connect the gate to the multiplexer circuit through contact hole 414, the drain electrode forms a bonding pad 416 is connected to the contact hole 418, and should be connected to the LED by a joint-metal 420-1. FIG. 4 shows only one bonding pad, but every LED has a positive electrode bonding pad, which also should be connected to the LED by joint-metals 420-2, 420-3 . . . 420-(N).

Please refer to FIG. 5. FIG. 5 is a cross sectional view through the line A-A′ of FIG. 4 according to one embodiment of the present invention.

The multiplexer device is in the left side and the LED is in the right side, the multiplexer device with gate 412, source 410 and drain 418, the source 410 is connected to the multiplexer circuit through metal layer of the source electrode 408, also the metal layer of the drain electrode 416 forms a bonding pad. A passivation layer of Si₃N₄ 510 is deposited on the metal layer, only the bonding pad area is exposed. The silicon multiplexer circuit chip has a through engraved U-shape trench 506. The linear array LED chip 404 is stack-hybridized into the through engraved U-shape trench 506. Such that the LED positive front electrode 406 is in the same plane of the bonding pad 416 of the multiplexer device. The back side of the LED chip is filled with conductive epoxy 508 to conduct the n-side of the pn junction 514 of the LED to the LED negative back electrode 516 of the LED chip 404, also we can see the plating AuTi 504 on the back side of the trench 506. On the front side of the LED chip, the void is filled with insulation adhesive photo-sensitive polyimide or BCB 512 to make the LED chip 404 connected to the silicon chip 402 more firmly. The positive electrode 406 of the LED is then connected to the bonding pad 416 of the multiplexer device by a joint-metal 420-1. The joint-metal can be formed by lithography and etching, screen printing of any solder paste, ink-jet printing of any appropriate solder paste or by lift-off method, which may make as small as the LED device. For example, 20 μm by 20 μm square or less, which is much smaller then a regular bonding pad area. Smaller bonding pad may increase the emitting area of the emitting light 518. Another advantage of the present invention is that it need not use the expansive mechanical wire-bonding process, this may reduce the cost of packaging.

Although specific embodiments of the invention have been disclosed, it will be understood by those having skill in the art that minor changes can be made to the form and details of the specific embodiments disclosed herein, without departing from the spirit and the scope of the invention.

The embodiments presented above are for purposes of example only and are not to be taken to limit the scope of the appended claims.

What is claimed is:

1. A packaging structure of LED-multiplexer/driver hybridization for LED printer head, comprising:
A linear array LED chip, made of non-silicon material;
A multiplexer chip, made of silicon material, has multiplexer circuit on one side and a through engraved U-shape trench on the other side, said linear array LED chip is stack-hybridized into said through engraved U-shape trench, to form a hybridized wafer with all the upper surfaces of LEDs and said multiplexer circuit in the same plane to form a co-planar surface;
A plurality of joint-metal, made by photo-lithography and etching, is formed on said co-planar surface of said multiplexer circuit and linear array LED to connect the bonding pad of the multiplexer device and the positive electrode of the LED of each pixel.

2. A package structure as recited in claim 1, wherein said photo-lithography of a plurality of joint-metal can be replaced by screen printing of any solder paste.

3. A package structure as recited in claim 1, wherein said photo-lithography of a plurality of joint-metal can be replaced by ink-jet printing of any appropriate solder paste.

4. A package structure as recited in claim 1, wherein said photo-lithography of a plurality of joint-metal can be replaced by lift-off method.

5. A package structure as recited in claim 1, wherein said non-silicon light emitting material is III-V compound material.

6. A package structure as recited in claim 1, wherein said non-silicon light emitting material is II-VI compound material.
